(19) United States
(12) Patent Application Publication
(10) Pub. No.: US 2024/0280758 A1
(43) Pub. Date: Aug. 22, 2024

(54) OPTICAL NODE, ROTATION ANGLE DEVIATION COMPENSATION SYSTEM AND ROTATION ANGLE DEVIATION COMPENSATION METHOD

(71) Applicant: NIPPON TELEGRAPH AND TELEPHONE CORPORATION, Tokyo (JP)

(72) Inventors: Tomohiro KAWANO, Musashino-shi, Tokyo (JP); Kazunori KATAYAMA, Musashino-shi, Tokyo (JP); Kazuhide NAKAE, Musashino-shi, Tokyo (JP); Hiroshi WATANABE, Musashino-shi, Tokyo (JP); Tatsuya FUJIMOTO, Musashino-shi, Tokyo (JP)

(73) Assignee: NIPPON TELEGRAPH AND TELEPHONE CORPORATION, Tokyo (JP)

(21) Appl. No.: 18/572,061

(22) PCT Filed: Jul. 9, 2021
(86) PCT No.: PCT/JP2021/025991

§ 371 Date: Dec. 19, 2023

(51) Int. Cl. G02B 6/35

(52) U.S. Cl. CPC G02B 6/354; G02B 6/3588

(57) ABSTRACT

An object of the present invention is to provide an optical node capable of compensating for a rotation angle deviation of an optical fiber core of a ferrule rotation type optical switch and reducing a connection loss generated in the optical switch.

An optical node according to the present disclosure includes: an input-side optical port to which optical test light is input; a first optical switch connected to the input-side optical port and having a plurality of channels; a first rotation mechanism that rotates the first optical switch; a second optical switch connected to the first optical switch and having a plurality of channels; a second rotation mechanism that rotates the second optical switch; an output-side port which is connected to the second optical switch and from which the optical test light is output; an optical port monitoring unit that performs optical intensity measurement of the optical test light passing through the output-side port; and an optical node control unit that is connected to the first rotation mechanism, the second rotation mechanism, and the optical port monitoring unit, causes the optical port monitoring unit to perform the optical intensity measurement after rotating the optical switch by a minute angle for each of a designated channel of the first optical switch and a designated channel of the second optical switch, extracts a rotation angle of the optical switch at which the optical intensity of the optical test light becomes a maximum value, and performs rotation angle deviation compensation for updating a database representing the rotation angle of each designated channel.

### TECHNICAL FIELD

The present invention mainly relates to an optical node having a function of driving an optical switch or a sensor by optical power supply in an optical fiber network.

### BACKGROUND ART

As an optical node that drives an optical switch by optical power supply from a remote place in a fiber network, for example, an optical node as described in Non Patent Literature 1 has been proposed. According to Non Patent Literature 1, an N×N switch is realized by combining 2N 1×N switches in multiple stages in an optical node operated by optical power supply.

In addition, for an all-optical switch that performs path switching while keeping light as it is, an optical switch has been proposed as disclosed in Non Patent Literature 2, for example. According to Non Patent Literature 2, an optical fiber type mechanical optical switch that controls abutment between optical fibers or optical connectors with a motor or the like is inferior to the other methods in that the switching speed is low, but has many aspects in which the optical fiber type mechanical optical switch is superior to the other methods in terms of low loss, low wavelength dependence, multi-port properties, and a self-retaining function of retaining the switching state at a time when the power supply is stopped.

### CITATION LIST

### Non Patent Literature

Non Patent Literature 1: Tatsuya Fujimoto et al., “Enkaku kouro kirikae node jitsugen ni muketa koukyuuden kouritsu no kentou (Study on Optical Power Supply Efficiency for Realization of Remote Optical Path Switching Node)”, The Institute of Electronics, Information and Communication Engineers (IEICE) General Conference, 2021, B-13-17, 2021. Non Patent Literature 2: Chisato Fukai et al., “Enkaku kouro kirikae node no sinsen kirikae ni okeru multi core fiber kaiten kikou no kentou (Study on Multicore Fiber Rotation Mechanism in Core Wire Switching of Remote Optical Path Switching Node)”, The Institute of Electronics, Information and Communication Engineers General Conference, 2021, B-13-18,2021.

### SUMMARY OF INVENTION

### Technical Problem

However, in the related art described in Non Patent Literature 1, since there is no means for checking whether the optical switches are connected with the minimum connection loss, there is a risk of an excessive loss occurring in the optical node. In addition, also in Non Patent Literature 2, there is a problem that, when optical fiber connection is switched by rotation of a motor or the like, there is no means for recovering the optical fiber core position in a case where opposing optical fiber core positions in the optical switch are deviated due to disturbance such as sliding or vibration of the rotation of the motor.

In order to solve the above problems, an object of the present invention is to provide an optical node, a rotation angle deviation compensation system, and a rotation angle deviation compensation method capable of compensating for a rotation angle deviation of an optical fiber core of a ferrule rotation type optical switch and reducing a connection loss generated in the optical switch.

### Solution to Problem

In order to achieve the above object, in an optical node, a rotation angle deviation compensation system, and a rotation angle deviation compensation method of the present disclosure, test light is input to a target port, an optical switch is switched to a designated channel, the optical switch is rotated by a minute angle, and a rotation angle at which measured optical intensity is maximized is stored as a set angle in the designated channel.

Specifically, an optical node according to the present disclosure includes:

an input-side optical port to which optical test light is input;

a first optical switch connected to the input-side optical port and having a plurality of channels;

a first rotation mechanism that rotates the first optical switch;

a second optical switch connected to the first optical switch and having a plurality of channels;

a second rotation mechanism that rotates the second optical switch;

an output-side port which is connected to the second optical switch and from which the optical test light is output;

an optical port monitoring unit that performs optical intensity measurement of the optical test light passing through the output-side port; and

an optical node control unit that is connected to the first rotation mechanism, the second rotation mechanism, and the optical port monitoring unit, causes the optical port monitoring unit to perform the optical intensity measurement after rotating the optical switch by a minute angle for each of a designated channel of the first optical switch and a designated channel of the second optical switch, extracts a rotation angle of the optical switch at which the optical intensity of the optical test light becomes a maximum value, and performs rotation angle deviation compensation for updating a database representing the rotation angle of each designated channel.

For example, in the optical node according to the present disclosure,

the first optical switch and the second optical switch have a configuration in which an input-side ferrule in which centers of one or a plurality of optical fiber cores are arranged on a circumference of a circle centered on a center in a cross section perpendicular to a long axis direction, and an output-side ferrule in which the centers of one or a plurality of optical fiber cores are arranged on the circumference of the circle centered on the center in the cross section perpendicular to the long axis direction, abut each other with central axes thereof in the long axis direction aligned, and

at least one of the input-side ferrule and the output-side ferrule rotates to switch a plurality of channels, and rotation by a minute angle is possible.

For example, the optical node according to the present disclosure further includes:

an input/output unit to which downlink light is input; and a power supply unit that stores the downlink light input to the input/output unit as electric power, and

the first rotation mechanism, the second rotation mechanism, the optical port monitoring unit, and the optical node control unit operate with electric power stored in the power supply unit.

For example, in the optical node according to the present disclosure,

the optical node control unit performs the rotation angle deviation compensation upon detecting vibration by itself or receiving a notification from the outside.

For example, in the optical node according to the present disclosure,

the optical node control unit performs the rotation angle deviation compensation every time the optical path is switched by the first optical switch or the second optical switch, or every time the optical path is switched a certain number of times.

Specifically, a rotation angle deviation compensation system according to the present disclosure includes :

the optical node; and a control device that supplies the downlink light to the power supply unit of the optical node and inputs the optical test light.

Specifically, a rotation angle deviation compensation system according to the present disclosure includes:

the optical node; and

a control device which includes a sensor connected to an external network or detecting vibration, and transmits detection of occurrence of a disaster or vibration to the optical node as the notification when the occurrence of the disaster is detected by the external network or the vibration is detected by the sensor.

Specifically, a rotation angle deviation compensation method according to the present disclosure includes:

inputting optical test light to an input-side port;

switching a first optical switch connected to the input-side port to a designated channel;

switching a second optical switch connected to the designated channel of the first optical switch to a designated channel;

performing optical intensity measurement of the optical test light output to an output-side port connected to the designated channel of the second optical switch; and

performing the optical intensity measurement after rotating the optical switch by a minute angle for each of the designated channel of the first optical switch and the designated channel of the second optical switch, extracting a rotation angle of the optical switch at which the optical intensity of the optical test light becomes a maximum value, and updating a database representing the rotation angle of each designated channel.

In the optical node, the rotation angle deviation compensation system, and the rotation angle deviation compensation method of the present disclosure, the test light is input to the target port, the optical switch is switched to the designated channel, the optical switch is rotated by a minute angle, and the rotation angle at which measured optical intensity is maximized is stored as a set angle in the designated channel. Accordingly, it is possible to provide an optical node, a rotation angle deviation compensation system, and a rotation angle deviation compensation method capable of compensating for a rotation angle deviation of an optical fiber core of a ferrule rotation type optical switch and reducing a connection loss generated in the optical switch.

Note that each of the above inventions can be combined in any possible manner.

### Advantageous Effects of Invention

According to the present disclosure, it is possible to provide an optical node, a rotation angle deviation compensation system, and a rotation angle deviation compensation method capable of compensating for a rotation angle deviation of an optical fiber core of a ferrule rotation type optical switch and reducing a connection loss generated in the optical switch.

### BRIEF DESCRIPTION OF DRAWINGS

FIG. 1 is an example of a configuration diagram of an optical node system of the present disclosure.

FIG. 2 is an example of a configuration diagram of an optical node of the present disclosure.

FIG. 3 is an example of a configuration diagram of an optical switch of the present disclosure.

FIG. 4 is an example of a flowchart illustrating a rotation angle deviation compensation method of the optical switch of the present disclosure.

FIG. 5 is an example of a diagram illustrating an example of an optical intensity measurement result in a rotation angle deviation compensation method of the optical switch.

FIG. 6 is an example of a diagram illustrating an example of the optical intensity measurement result in the rotation angle deviation compensation method of the optical switch.

FIG. 7 is an example of a diagram illustrating an example of database update in a case where a minute angular deviation occurs in the rotation angle deviation compensation method of the optical switch.

### DESCRIPTION OF EMBODIMENTS

Hereinafter, embodiments of the present disclosure will be described in detail with reference to the drawings. Note that the present invention is not limited to the following embodiments. These examples are merely examples, and the present disclosure can be implemented in a form with various modifications and improvements based on the knowledge of those skilled in the art. Note that components having the same reference numerals in the present specification and the drawings indicate the same components.

### Embodiment 1

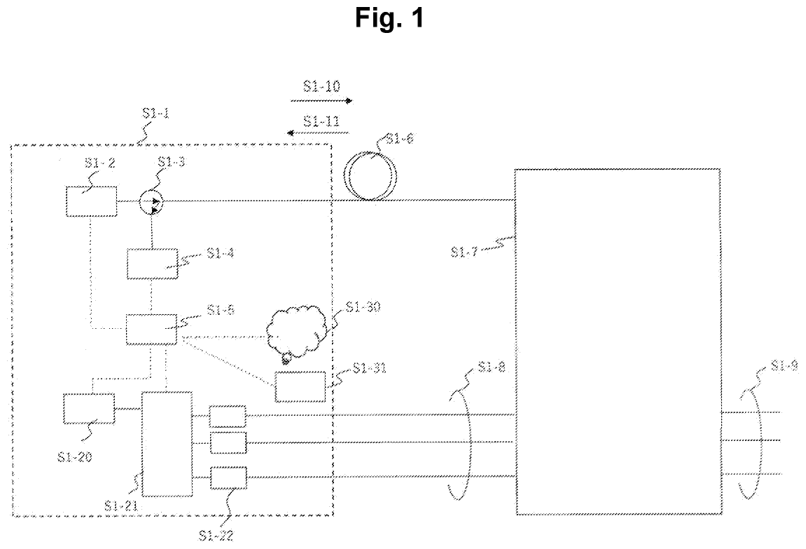

FIG. 1 illustrates an example of a configuration of an optical node system according to an embodiment of the present invention. A control device S1-1 illustrated in FIG. 1 is installed in an environment where a power source can be provided, and includes a light source S1-2, an optical circulator S1-3, an optical receiver S1-4, a controller S1-5, an optical test light source S1-20, an optical selector S1-21, an optical test light input coupler S1-22, a disaster information acquisition external network S1-30, and a vibration detection sensor S1-31. Laser light emitted from the light source S1-2 is input to a transmission line optical fiber S1-6 via the optical circulator S1-3. For example, the wavelength of the laser light can be 1480 nm to 1490 nm. The power of the laser light output from the light source S1-2 may be approximately +10 to 17 dBm. The laser light is used to supply light to an optical node S1-7.

The optical node S1-7 is installed at any location, for example, a place where there is no power source, and is connected to the control device S1-1 via the transmission line optical fiber S1-6. A plurality of transmission line optical fibers other than the transmission line optical fiber (hereinafter referred to as input/output optical fibers S1-8 and S1-9 in order to distinguish them from the transmission line optical fiber S1-6) are connected to the optical node S1-7.

The optical selector S1-21 has a plurality of ports and is connected to the optical node S1-7 via the optical test light input coupler S1-22 and the input/output optical fiber S1-8. In addition, the optical selector S1-21 is connected to the optical test light source S1-20, and inputs optical test light S2-200, which will be described later, from the optical test light source S1-20 to the optical node S1-7 from any port thereof via the optical test light input coupler S1-22 and the input/output optical fiber S1-8.

The disaster information acquisition external network S1-30 and the vibration detection sensor S1-31 are connected to the controller S1-5, and are used to quickly detect an impact when a disaster such as an earthquake, in which there is a high risk of rotation angle deviation of an optical switch occurring, or an accident accompanied by an impact occurs, and compensate for the rotation angle deviation, as will be described later. As the vibration detection sensor S1-31, for example, a uniaxial or biaxial acceleration sensor may be used.

The controller S1-5 may have a function of analyzing an uplink frame included in uplink light S1-11 from the optical node S1-7 received by the optical receiver S1-4. The uplink frame may include an input instruction or the like of the optical test light S2-200 which will be described later.

In addition, when the external network S1-30 and the vibration detection sensor S1-31 detect that a disaster such as an earthquake, in which there is a high risk of rotation angle deviation of the optical switch occurring, or an accident accompanied by an impact has occurred, the controller S1-5 may cause the light source S1-2 to output downlink light S1-10 including an instruction to perform detection of occurrence of the disaster or vibration or rotation angle deviation compensation which will be described later.

Further, the controller S1-5 may control the optical test light source S1-20 and the optical selector S1-21 to input the optical test light S2-200, which will be described later, to the optical node S1-7 from a selected port of the optical selector S1-21 in the rotation angle deviation compensation. Then, the controller S1-5 may notify the optical node S1-7 of the port to which the optical test light S2-200 is input by using the downlink light S1-10.

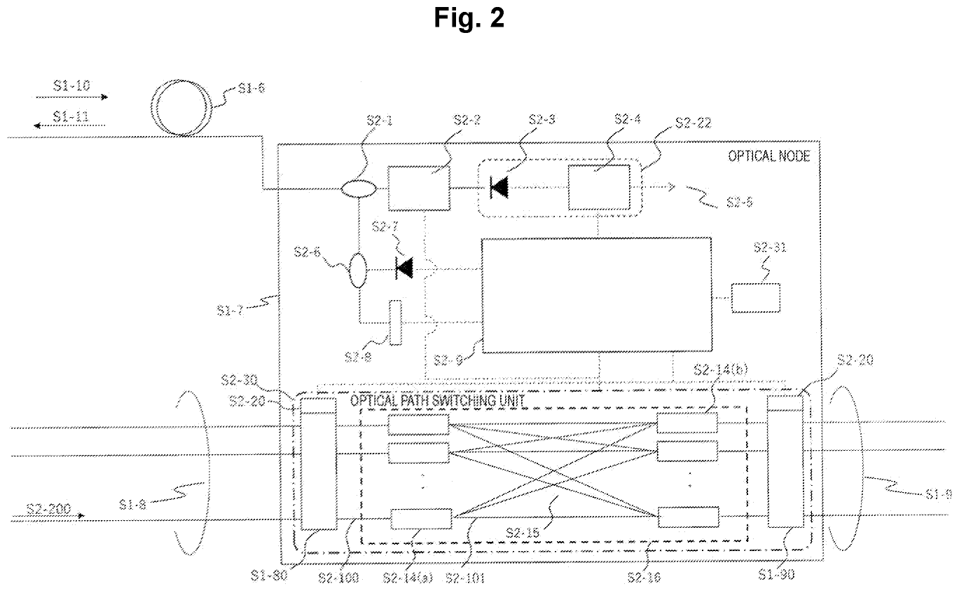

FIG. 2 illustrates an example of an internal configuration of the optical node S1-7.

The optical node S1-7 according to the present embodiment includes:

an input-side optical port (S1-80) to which optical test light is input;

a first optical switch (S2-14(a)) connected to the input-side optical port and having a plurality of channels;

a first rotation mechanism (S3-1) that rotates the first optical switch;

a second optical switch (S2-14(b)) connected to the first optical switch and having a plurality of channels;

a second rotation mechanism (S3-1) that rotates the second optical switch;

an output-side port (S1-90) which is connected to the second optical switch and from which the optical test light is output;

an optical port monitoring unit (S2-20) that performs optical intensity measurement of the optical test light passing through the output-side port; and an optical node control unit (S2-9) that is connected to the first rotation mechanism, the second rotation mechanism, and the optical port monitoring unit, causes the optical port monitoring unit to perform the optical intensity measurement after rotating the optical switch by a minute angle for each of a designated channel of the first optical switch and a designated channel of the second optical switch, extracts a rotation angle of the optical switch at which the optical intensity of the optical test light becomes a maximum value, and performs rotation angle deviation compensation for updating a database representing the rotation angle of each designated channel.

The optical node S1-7 illustrated in FIG. 2 includes

an optical branching unit S2-1 that functions as an input/output unit to which the downlink light S1-10 including a modulation period and a non-modulation period is input and which outputs the uplink light S1-11 including information;

an input gate optical switch S2-2 that transmits the downlink light S1-10 input to the optical branching unit S2-1 only in a specific period and supplies the downlink light S1-10 to a power supply unit S2-22;

an optical receiver S2-7 that constantly receives the downlink light S1-10 input to the optical branching unit S2-1; and

a reflection optical switch S2-8 that performs reflection and non-reflection on the downlink light S1-10 in the non-modulation period within the downlink light S1-10 input to the optical branching unit S2-1 based on the information to generate the uplink light S1-11.

In order for the optical node S1-7 to have a function of optical path switching, the optical node S1-7 may further include an optical path switching unit S2-30 that operates with the electric power stored in the power supply unit S2-22 and switches a plurality of optical paths in any manner, and may set a state of the optical path and the input instruction of the optical test light as the information.

The optical path switching unit S2-30 includes:

a plurality of optical ports (S1-80, S1-90) each connected to a plurality of communication optical fibers (S1-8, S1-9);

an optical path switching switch (cross-connect unit S2-16) that operates with the electric power stored in the power supply unit S2-22 and switches the optical paths such that an optical signal input to the optical ports (S1-80, S1-90) is output to any other optical port (S1-80, S1-90); and

an optical port monitoring unit S2-20 that monitors the optical signal passing through the optical ports (S1-80, S1-90) and monitors a state of the optical path.

The optical node S1-7 illustrated in FIG. 2 supplies drive power S2-5 of all the active elements included in the optical node S1-7 to the downlink light S1-10 from the transmission line optical fiber S1-6 via an optical branching unit S2-1, an input gate optical switch S2-2, a photoelectric conversion element S2-3, and a secondary battery S2-4. The photoelectric conversion element S2-3 and the secondary battery S2-4 are a “power supply unit S2-22”, and the input gate optical switch S2-2, the reflection optical switch S2-8, the cross-connect unit S2-16, the optical port monitoring unit S2-20, and the optical node control unit S2-9, which will be described later, are included in the active elements.

The optical branching unit S2-1 is a branching ratio coupler and guides optical power to the input gate optical switch S2-2.

The input gate optical switch S2-2 serves as a gate switch capable of selecting whether to transmit the downlink light S1-10 having passed through the optical branching unit S2-1 to another path or not, and accordingly, can control the plurality of optical nodes S1-7 by connecting another optical node S1-7 to another path. In addition, the input gate optical switch S2-2 may function as a gate switch capable of selecting whether or not to transmit the downlink light S1-10 having passed through the optical branching unit S2-1 to the photoelectric conversion element S2-3, and may be used to prevent overcharge of the secondary battery S2-4. Since the input gate optical switch S2-2 operates frequently, it is desirable that the input gate optical switch S2-2 operate with a low voltage and extremely small power consumption of several nW or less. For example, as the input gate optical switch S2-2, a generally available and electrostatically driven MEMS optical switch having small drive power may be used.

As the photoelectric conversion element S2-3, a photoelectric conversion element capable of receiving the wavelength of the laser light emitted from the light source S1-2 is used. As the photoelectric conversion element S2-3, a readily available element suitable for a long wavelength band of 1300 nm to 1600 nm for communication, for example, an element including indium gallium arsenide and having an open voltage of 5 V or less and a conversion efficiency of approximately 30%, can be used. For example, the photoelectric conversion element S2-3 is an optical feed converter (https://www.kyosemi.co.jp/resources/ja/products/sensor/nir_photodiode/kpc 8_t/kpc8_t_spec.pdf). When the power of the laser light transmitted through the transmission line optical fiber S1-6 is, for example, approximately 2 mW, the laser light can be used for optical power supply. Note that the power varies depending on a device used as optical power supply.

The secondary battery S2-4 is used to store the power energy converted by the photoelectric conversion element S2-3, and for example, an electric double layer capacitor or the like is used. In the voltage supply to each active element, a boosted voltage can be adjusted as appropriate by a DC/DC converter or the like.

The other of the optical branching units S2-1 is guided to another optical branching unit S2-6 and input to the optical receiver S2-7 and the reflection optical switch S2-8. The optical receiver S2-7 is always disposed to receive the downlink light S1-10 regardless of a path state of the input gate optical switch S2-2, and receives a control signal from the control device S1-1.

The reflection optical switch S2-8 is an optical switch capable of controlling ON/OFF as to whether to totally reflect a part of the downlink light S1-10. The reflection optical switch S2-8 modulates the uplink light toward the control device S1-1 by using the downlink light S1-10. The reflection optical switch S2-8 desirably operates at a low voltage and extremely low power consumption of several nW or less. For example, as the reflection optical switch S2-8, a generally available and electrostatically driven MEMS optical switch having small drive power may be used.

In the example in FIG. 2, the optical cross-connect unit S2-16 includes a plurality of optical switches S2-14. In the optical cross-connect unit S2-16, a plurality of optical switches S2-14(a) having one input and N outputs are arranged on the optical port S1-80 side, a plurality of optical switches S2-14(b) having N inputs and one output are arranged on the optical port S1-90 side, and the optical switches are cross-wired therebetween by an optical waveguide wiring S2-15. The optical cross-connect unit S2-16 is an N×N port optical cross-connect. Note that a wiring of the optical waveguide wiring S2-15 is free depending on an application, and for example, a wiring such as a fold-back wiring may also be used by folding back any partial port among the N ports and connecting the port to another optical switch S2-14 on the same side. In addition, the number of input/output ports of the optical cross-connect unit S2-16 does not need to be symmetrical, and for example, an asymmetric configuration such as M×N may be employed. As described above, the optical cross-connect unit S2-16 is configured by the plurality of optical switches S2-14 as in the present example.

However, the standby power consumption of the optical cross-connect unit S2-16 greatly affects the power management of the entire system. Therefore, it is preferable that the optical switch S2-14 be a self-retention type optical switch having a feature that power is not required at the time of standby and the switching state is retained even at the time of power loss.

The reason why the optical cross-connect unit S2-16 has a configuration in which the plurality of optical switches S2-14 are arranged on both sides of the optical ports (S1-80, S1-90) is as follows. Normally, a self-retention type optical switch having a plurality of output ports has a phenomenon in which light is output to an unintended port in the middle of a switching operation, which may lead to a communication accident. Providing a plurality of optical switches on both the input side and the output side requires switching of at least two optical switches to switch one optical path. Even when one optical switch outputs light to an unintended port, the other optical switch can block the light, and thus it is possible to prevent a communication accident caused by unintended light output.

Further, the optical path switching unit S2-30 includes an optical port monitoring unit S2-20 that monitors connection information for the optical cross-connect unit S2-16. The optical port monitoring unit S2-20 is disposed on the optical port S1-80 side and the optical port S1-90 side of the optical cross-connect unit S2-16, and optically branches and receives communication light or test light input from the input/output optical fiber S1-8 and communication light or test light output from the input/output optical fiber S1-9, and thus monitors the ports of the plurality of optical switches S2-14 in the optical cross-connect unit S2-16. As means used for the optical port monitoring unit S2-20 to optically branch the communication light or the test light, for example, there is a generally available 99:1 optical coupler. Furthermore, examples of the optical receiver that reads the optically branched light include a generally available photodiode.

For each optical switch S2-14, the optical port monitoring unit S2-20 may extract a part of the optical signal passing through the optical fiber connected to each channel on the input side and each channel on the output side of the optical switch S2-14, for example, the input-side optical fiber S2-100 and the output-side optical fiber S2-101 to be described later, and measure the optical intensity.

The optical port monitoring unit S2-20 can check an optical port that is a switching target before switching the optical cross-connect unit S2-16 or check whether the optical port has been correctly switched after switching the optical cross-connect unit S2-16, and can set these as a “state of the optical path”. In addition, by monitoring the optical loss by the optical port monitoring unit S2-20 of the plurality of optical nodes S1-7, when an abnormality such as disconnection of the optical transmission line including the input/output optical fibers (S1-8 and S1-9) occurs, it is possible to specify between which nodes the abnormality occurs. As described above, a location where the abnormality of the plurality of optical nodes S1-7 detected by the optical port monitoring unit S2-20 occurs can also be set as a “state of the optical path”.

The optical node S1-7 includes an optical node control unit S2-9 for control. The optical node control unit S2-9 may have

a power control function of monitoring a power storage amount in the power supply unit S2-22;

a downlink frame analysis function of analyzing a modulated signal included in the downlink light in the modulation period;

a switching operation control function of giving a switching instruction for the input gate optical switch S2-2 based on the power storage amount, and giving a switching instruction for the optical path switching unit S2-30 based on an analysis result of the modulated signal;

an optical port monitoring function of setting the “state of the optical path” as the information; and

an uplink signal generation function for driving the reflection optical switch S2-8 based on the information.

These five functions (1) to (5) will be described.

### (1) Downlink Frame Analysis Function

The downlink frame analysis function is a function of analyzing a downlink frame included in the downlink light S1-10 from the control device S1-1 received by the optical receiver S2-7. The light source S1-2 of the control device S1-1 applies intensity modulation to the output laser light based on a signal from the controller S1-5, and sets the output laser light as an information downlink frame such as a time-to-live (TTL) signal or a CMOS signal. The frame includes a request for node information, an execution instruction related to switch (the input gate optical switch S2-2 and the optical switch S2-14) switching, and the like. In addition, the downlink frame may include a notification of occurrence of a disaster or a notification of detection of vibration detected by the external network S1-30 or the vibration detection sensor S1-31, or an instruction to perform rotation angle deviation compensation which will be described later.

### (2) Uplink Signal Generation Function

The uplink signal generation function is a function of cooperating with the downlink frame analysis function to set the “state of the optical path” and the input instruction of the optical test light as the information, and modulating the reflection optical switch S2-8 to generate the uplink signal light S1-11.

### (3) Switching Operation Control Function

The switching operation control function cooperates with the downlink frame analysis function to designate the input gate optical switch S2-2 that is a switching target or any optical switch S2-14 included in the optical cross-connect unit S2-16, and issues a switching command to any port. As a specific circuit configuration for realizing the switching operation control function, a circuit that delivers an instruction to a drive circuit having any address through bus communication (for example, I2C) with the optical node control unit S2-9 as a master to a drive circuit attached to each optical switch and controls a switching operation of any optical switch S2-14 may be exemplified.

### (4) Power Monitoring Function

The power monitoring function is a function of monitoring the stored energy amount of the secondary battery S2-4. The optical node control unit S2-9 always ascertains a stored energy amount in the secondary battery S2-4 via a voltage monitor or the like, and notifies the control device S1-1 via the uplink signal generation function based on a set threshold value.

### (5) Optical Port Monitoring Function

The optical port monitoring function is a function of monitoring optical port information of the optical port monitoring unit S2-20. When there is an inquiry from the control device S1-1, the optical node control unit S2-9 ascertains optical port information via a voltage monitor or the like of an optical receiver provided in the optical port monitoring unit S2-20, and notifies the control device S1-1 via the uplink signal generation function.

As described above, the optical node control unit S2-9 can realize that the optical node S1-7 itself manages the stored energy amount, performs uplink communication with the control device S1-1, and performs downlink communication for receiving an execution instruction from the control device S1-1 by causing the five functions to cooperate with each other.

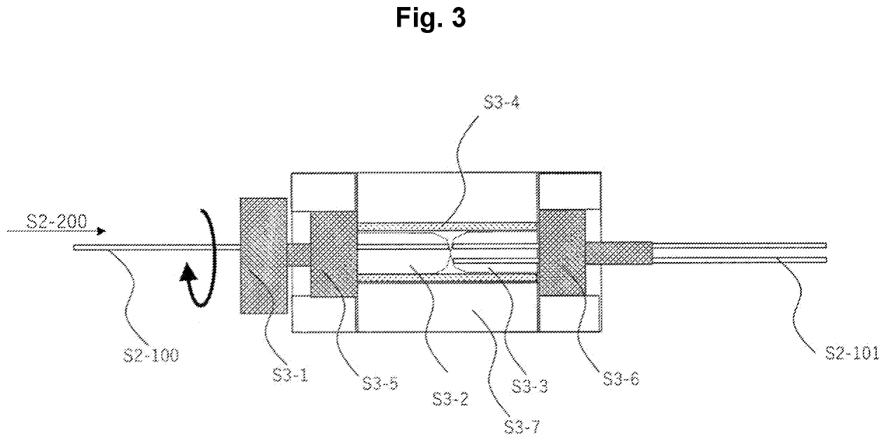

An example of a structure of the 1×N optical switches S2-14 constituting the optical cross-connect unit S2-16 will be described with reference to FIG. 3. As a structure of the 1×N optical switch S2-14, as illustrated in FIG. 3, an input-side ferrule S3-2 in which the input-side optical fiber S2-100 is installed and an output-side ferrule S3-3 in which the N output-side optical fibers S2-101 are installed are butted with each other in a state where the input-side ferrule S3-2 and the output-side ferrule are positioned by a sleeve S3-4.

For example, the output-side ferrule S3-3 may have a structure in which the centers of the N output-side optical fibers S2-101 are on the same circumference centered on the center of the output-side ferrule S3-3 in the ferrule cross section. For example, the input-side ferrule S3-2 may have a structure in which the center of the input-side optical fiber S2-100 is on the same circumference as the circumference of the output-side ferrule S3-3 where the output-side optical fiber S2-101 is disposed with the center of the input-side ferrule S3-2 as the center in the ferrule cross section. In addition, the sleeve S3-4 may position the input-side ferrule S3-2 and the output-side ferrule S3-3 such that the central axes of the input-side ferrule S3-2 and the output-side ferrule S3-3 in the long axis direction are aligned with each other. Note that the input-side optical fiber S2-100 is an optical fiber of the input/output optical fiber S1-8 on which optical test light S2-200, which will be described later, is incident.

The sleeve S3-4 is fixed by a fixing jig S3-7. A flange is attached to each ferrule (S3-2, S3-3) (S3-5, S3-6). For example, in the optical cross-connect unit S2-16, as illustrated in FIG. 3, the ferrule rotating actuator S3-1 is attached as a rotation mechanism to the input-side flange S3-5 of the optical switch S2-14, and accordingly, the input-side ferrule S3-2 is rotated to realize switching. The ferrule rotating actuator S3-1 is supplied with drive power S2-5 from the optical node S1-7, receives a rotation control signal from the optical node control unit S2-9, and can rotate at any rotation angle. The optical switch S2-14(a) illustrated in FIG. 2 may have a structure similar to the structure of the 1×N optical switch S2-14 in FIG. 3, and the optical switch S2-14(b) illustrated in FIG. 2 may have a structure of the N×1 optical switch obtained by horizontally inverting the structure of the 1×N optical switch S2-14 in FIG. 3. Similarly to the 1×N optical switch, the ferrule rotating actuator S3-1 may be attached as a rotation mechanism to the N×1 optical switch which is the optical switch S2-14(b).

In addition, the vibration detection sensor S2-31 is also provided in the optical node S1-7 to be connected to the optical node control unit S2-9, and can detect vibration due to disturbance.

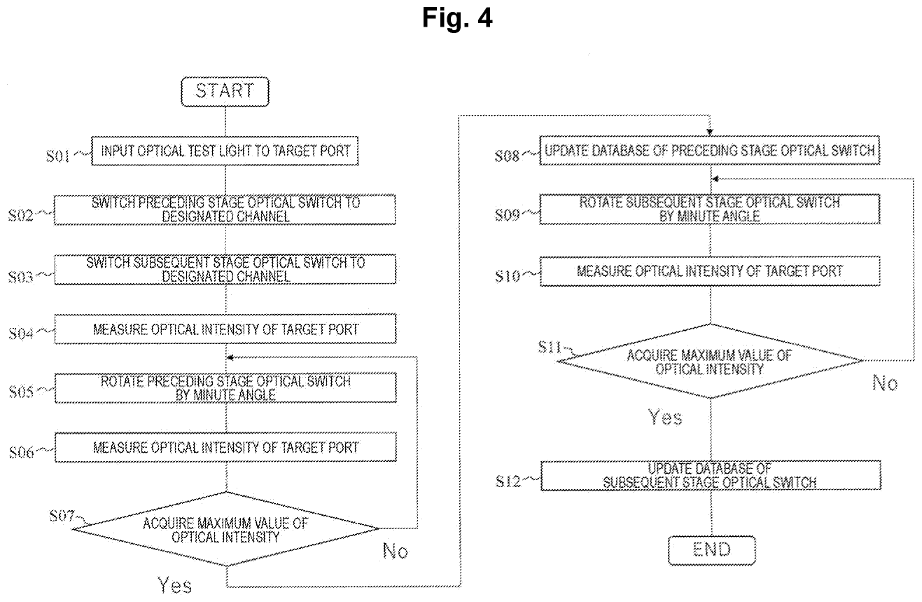

Next, a rotation angle deviation compensation method in a case where the rotation angle deviation of the optical fiber core of the optical switch S2-14 occurs due to disturbance such as slip or impact of the ferrule rotating actuator S3-1 itself at the time of switching the optical switch S2-14 will be described with reference to FIG. 4. Note that the optical node control unit S2-9 may perform rotation angle deviation compensation every time the optical path is switched by the optical switch S2-14.

First, a target port is selected by the optical selector S1-21, and the optical test light S2-200 is input through the optical test light input coupler S1-22 (step S01). Next, the optical switch S2-14(a) on the input side (preceding stage) is switched to the designated channel (step S02). Thereafter, the optical switch S2-14(b) on the output side (subsequent stage) is switched to the designated channel (step S03).

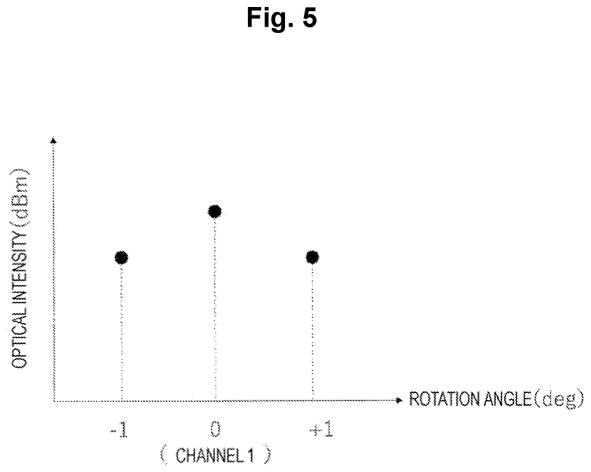

The optical port monitoring unit S2-20 measures the optical intensity of the optical test light S2-200 output from the designated channel of the optical switch S2-14(b) (step S04). Next, the optical switch S2-14(a) in the preceding stage rotates in the positive and negative directions by a minute angle, for example, 1 degree (step S05). After the optical switch S2-14(a) rotates, the optical intensity of the optical test light S2-200 output from the designated channel of the optical switch S2-14(b) is measured (step S06), and the maximum value of the optical intensity is acquired (step S07). In step S07, for example, as illustrated in FIG. 5, in a case where the measurement is performed at three angles (−1 degree, 0 degrees, 1 degree), when a peak value is obtained at the middle angle (0 degrees) among the three angles, it is determined that the maximum value can be acquired, and the processing proceeds to the next process step S08. The maximum value may be a peak value when the peak value is obtained at the middle angle among the three angles.

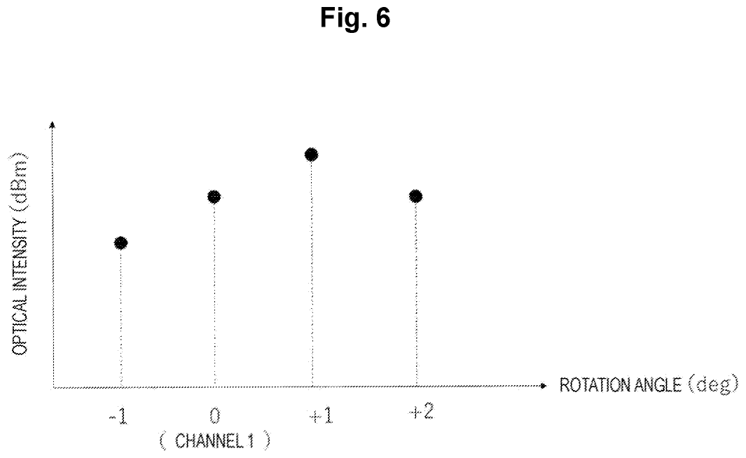

When the maximum value cannot be obtained at the three angles (−1 degree, 0 degrees, 1 degree) as illustrated in FIG. 6, that is, when the peak value cannot be obtained at the middle angle (0 degrees) among the three angles (−1 degree, 0 degrees, 1 degree), the process returns to step S05, the rotation is further performed to obtain the maximum value by a minute angle, and the maximum value is obtained. In FIG. 6, since the maximum value cannot be acquired at the rotation angles of −1 degree, 0 degrees, and 1 degree, the above-described optical intensity measurement is further performed with the rotation angle set to 2 degrees, and the results are shown. In FIG. 6, focusing on the optical intensities of 0 degrees, 1 degree, and 2 degrees, the peak value was obtained at 1 degree, which is the middle angle, and thus, it can be determined that the maximum value was obtained.

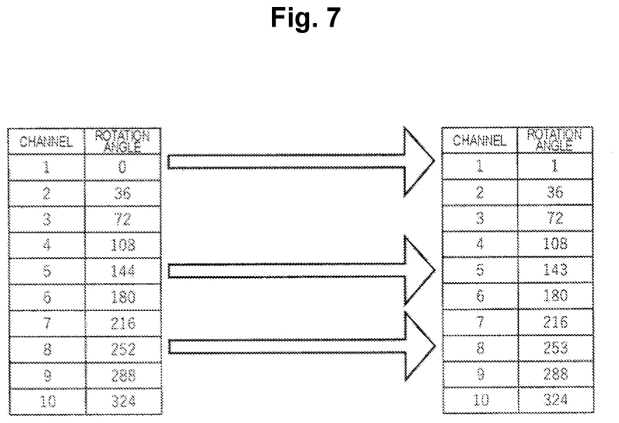

For the optical switch S14-2 having 10 channels, a database representing each channel and the rotation angle corresponding to the channel is illustrated in FIG. 7. When the maximum value of the optical intensity can be acquired, the database is updated as illustrated in FIG. 7 (step S08). The database may be updated only when the rotation angle at which the maximum value can be acquired is different from the preset rotation angle. FIG. 7 illustrates an example in which the database is updated for the channels 1, 5, and 8, but the present invention is not limited thereto. The data can be utilized next time by updating the database.

When the rotation angle deviation compensation of the optical switch S2-14(a) in the preceding stage is completed, the optical switch S2-14(b) in the subsequent stage similarly rotates by a minute angle (step S09). After the optical switch S2-14(b) rotates, the optical intensity of the optical test light S2-200 output from the designated channel of the optical switch S2-14(b) is similarly measured (step S10). Steps S09 and S10 are performed until the maximum value of the optical test light S2-200 can be acquired (step S11). When the maximum value of the optical intensity can be acquired, the database is updated (step S12), and the process of the rotation angle deviation compensation method is completed.

The optical node control unit S2-9 included in the optical node S1-7 according to the present invention can also be realized by a computer and a program, and the program can also be recorded in a recording medium or provided through a network.

### Embodiment 2

Hereinafter, an optical node, a rotation angle deviation compensation method, and a rotation angle deviation compensation system according to the present embodiment will be described. In the present embodiment, only the timing at which the rotation angle deviation compensation is performed is different from that in Embodiment 1.

As described in Embodiment 1, when the rotation angle deviation compensation is performed every time the optical path is switched by the optical switch S2-14, the optimum optical connection state can be realized at each switching, but the use frequency increases accordingly, and extra electric power may be consumed (sequential compensation mode).

Therefore, as an example of the operation, for example, the power consumption can be suppressed from the sequential compensation mode by performing the rotation angle deviation compensation every fixed number of times of switching of the optical switch S2-14 (periodic compensation mode).

In addition, when a strong impact occurs in the optical node S1-7 due to a natural disaster such as an earthquake or an accident instead of the timing of the optical switching, it is necessary to immediately detect the impact and perform the rotation angle deviation compensation (emergency compensation mode). The impact may be detected by, for example, the vibration detection sensor S2-31 provided in the optical node S1-7 or the vibration detection sensor S1-31 provided in the control device S1-1. Alternatively, the control device S1-1 may be connected to the external network S1-30 and acquire information to perform impact detection.

### Effects of Present Invention

As described above in the two embodiments, by using the optical node, the rotation angle deviation compensation system, and the rotation angle deviation compensation method of the present invention, it is possible to significantly reduce the risk of increasing the loss of the optical connection of the optical switch, and thus it is possible to provide a highly reliable optical fiber network system.

Note that each of the above inventions can be combined in any possible manner.

### INDUSTRIAL APPLICABILITY

The optical node, the rotation angle deviation compensation system, and the rotation angle deviation compensation method according to the present disclosure can be applied to the information communication industry.

REFERENCE SIGNS LIST
S1-1 Control device
S1-2 Light source
S1-3 Optical circulator
S1-4 Optical receiver
S1-5 Controller
S1-6 Transmission line optical fiber
S1-7 Optical node
S1-8 Input/output optical fiber
S1-9 Input/output optical fiber
S1-10 Downlink light
S1-11 Uplink light
S1-20 Optical test light source
S1-21 Optical selector
S1-22 Optical test light input coupler
S1-30 External network
S1-31 Vibration detection sensor
S1-80, S1-90 Optical port
S2-1 Optical branching unit
S2-2 Input gate optical switch
S2-3 Photoelectric conversion element
S2-4 Secondary battery
S2-5 Drive power
S2-6 Optical coupler
S2-7 Optical receiver
S2-8 Reflection optical switch
S2-9 Optical node control unit
S2-14 Optical switch
S2-15 Optical waveguide wiring
S2-16 Optical cross-connect unit
S2-20 Optical port monitoring unit
S2-22 Power supply unit
S2-30 Optical path switching unit
S2-31 Vibration detection sensor
S2-100 Input-side optical fiber
S2-101 Output-side optical fiber
S2-200 Optical test light
S3-1 Ferrule rotating actuator
S3-2 Input-side ferrule
S3-3 Output-side ferrule
S3-4 Sleeve
S3-5 Input-side flange
S3-6 Output-side flange
S3-7 Fixing jig

1. An optical node comprising:
an input-side optical port to which optical test light is input;
a first optical switch connected to the input-side optical port and having a plurality of channels;
a first rotation mechanism that rotates the first optical switch;
a second optical switch connected to the first optical switch and having a plurality of channels;
a second rotation mechanism that rotates the second optical switch;
an output-side port which is connected to the second optical switch and from which the optical test light is output;
an optical port monitoring unit that performs optical intensity measurement of the optical test light passing through the output-side port; and
an optical node control unit that is connected to the first rotation mechanism, the second rotation mechanism, and the optical port monitoring unit, causes the optical port monitoring unit to perform the optical intensity measurement after rotating the optical switch by a minute angle for each of a designated channel of the first optical switch and a designated channel of the second optical switch, extracts a rotation angle of the optical switch at which the optical intensity of the optical test light becomes a maximum value, and performs rotation angle deviation compensation for updating a database representing the rotation angle of each designated channel.

2. The optical node according to claim 1, wherein
the first optical switch and the second optical switch have a configuration in which an input-side ferrule in which centers of one or a plurality of optical fiber cores are arranged on a circumference of a circle centered on a center in a cross section perpendicular to a long axis direction, and an output-side ferrule in which the centers of one or a plurality of optical fiber cores are arranged on the circumference of the circle centered on the center in the cross section perpendicular to the long axis direction, abut each other with central axes thereof in the long axis direction aligned, and
at least one of the input-side ferrule and the output-side ferrule rotates to switch a plurality of channels, and rotation by a minute angle is possible.

3. The optical node according to claim 1, further comprising:
an input/output unit to which downlink light is input; and
a power supply unit that stores the downlink light input to the input/output unit as electric power, wherein
the first rotation mechanism, the second rotation mechanism, the optical port monitoring unit, and the optical node control unit operate with electric power stored in the power supply unit.

4. The optical node according to claim 1, wherein
the optical node control unit performs the rotation angle deviation compensation upon detecting vibration by itself or receiving a notification from the outside.

5. The optical node according to claim 1, wherein
the optical node control unit performs the rotation angle deviation compensation every time the optical path is switched by the first optical switch or the second optical switch, or every time the optical path is switched a certain number of times.

6. A rotation angle deviation compensation system comprising:
the optical node according to claim 3; and
a control device that supplies the downlink light to the power supply unit of the optical node and inputs the optical test light.

7. A rotation angle deviation compensation system comprising:
the optical node according to claim 4; and
a control device which includes a sensor connected to an external network or detecting vibration, and transmits detection of occurrence of a disaster or vibration to the optical node as the notification when the occurrence of the disaster is detected by the external network or the vibration is detected by the sensor.

8. A rotation angle deviation compensation method comprising:
inputting optical test light to an input-side port;
switching a first optical switch connected to the input-side port to a designated channel;
switching a second optical switch connected to the designated channel of the first optical switch to a designated channel;
performing optical intensity measurement of the optical test light output to an output-side port connected to the designated channel of the second optical switch; and
performing the optical intensity measurement after rotating the optical switch by a minute angle for each of the designated channel of the first optical switch and the designated channel of the second optical switch, extracting a rotation angle of the optical switch at which the optical intensity of the optical test light becomes a maximum value, and updating a database representing the rotation angle of each designated channel.
